(19) United States
(12) Patent Application Publication
(10) Pub. No.: US 2019/0077091 A1
(43) Pub. Date: Mar. 14, 2019

(54) COLOR THREE-DIMENSIONAL SHAPING APPARATUS AND METHOD FOR CONTROLLING COLOR THREE-DIMENSIONAL SHAPING APPARATUS

(71) Applicant: SEIKO EPSON CORPORATION, Tokyo (JP)

(72) Inventors: Takuya WAKAYAMA, Matsumoto, Nagano (JP); Kohei UTSUNOMIYA, Matsumoto, Nagano (JP); Eishin YOSHIKAWA, Shiojiri, Nagano (JP); Seiichi TANIGUCHI, Higashichikuma-gun, Asahi-mura, Nagano (JP)

(21) Appl. No.: 16/084,347

(22) PCT Filed: Mar. 7, 2017
(86) PCT No.: PCT/JP2017/009051

§ 371 Date: Sep. 12, 2018

(30) Foreign Application Priority Data
Mar. 14, 2016 (JP) 2016-049272
Mar. 14, 2016 (JP) 2016-049273
Mar. 14, 2016 (JP) 2016-049274

(51) Int. Cl. B29C 67/00; B41M 5/00; B44C 1/175

(52) U.S. Cl. CPC B29C 67/0007; B33Y 10/00; B44C 1/175; B41M 5/00

(57) ABSTRACT

A color three-dimensional shaping apparatus includes a data acquisition unit configured to acquire data on a 3D object as input data, a data creation unit configured to create first data regarding shapes of layers obtained by dividing the 3D object into multiple layers and second data regarding a surface color of the 3D object from the input data, a three-dimensional shaping unit configured to three-dimensionally shape the 3D object, based on the first data, a conveyance unit configured to convey a three-dimensional shaped object three-dimensionally shaped by the three-dimensional shaping unit, and a coloring unit configured to impart the surface color to the three-dimensional shaped object conveyed by the conveyance unit, based on the second data.

### CROSS-REFERENCE TO RELATED APPLICATIONS

This application claims priority under 35 U.S.C. § 119 to Japanese Patent Application No. 2016-049272, filed Mar. 14 2016, Japanese Patent Application No. 2016-049273, filed Mar. 14 2016 and Japanese Patent Application No. 2016-049274, filed Mar. 14 2016. The entire disclosures of Japanese Patent Application Nos. 2016-049272, 2016-049273 and 2016-049274 are expressly incorporated by reference herein.

### TECHNICAL FIELD

The present invention relates to a color three-dimensional shaping apparatus and a method for controlling the color three-dimensional shaping apparatus.

### BACKGROUND ART

A so-called 3D printer is known in art as a shaping apparatus for shaping a three-dimensional shaped object (also referred to as a three-dimensional structure), based on input data (for example, see JP-A-2015-202597 and JP-UM-A-6-81727). The three-dimensional shaped object shaped using such a type of shaping apparatus allows accurate colorization through coloring performed by a human being. Meanwhile, as a technique for coloring a solid article, a hydraulic transfer apparatus based on water pressure transfer technology is known in the art (for example, see JP-A-2009-269342).

### SUMMARY

When the hydraulic transfer apparatus of the related art is employed, coloring is performed inevitably by setting a three-dimensional shaped object on a hydraulic transfer apparatus after performing three-dimensional shaping using a 3D printer. For this reason, in the case of coloring to be performed with high positioning accuracy, accurate positioning is indispensable, and time and efforts are needed until the color three-dimensional shaped object is completed.

In this regard, it is an advantage of the present invention to easily fabricate the color three-dimensional shaped object.

The present invention has been made to satisfy at least a part of the aforementioned demands in the art, and may be embodied as the following exemplary embodiments and application examples.

In order to obtain the aforementioned advantages, according to an aspect of the present invention, there is provided a color three-dimensional shaping apparatus including a data acquisition unit configured to acquire data on a 3D object as input data, a data creation unit configured to create, from the input data, first data regarding shapes of respective layers obtained by dividing the 3D object into multiple layers and second data regarding a surface color of the 3D object, a three-dimensional shaping unit configured to three-dimensionally shape the 3D object, based on the first data, a conveyance unit configured to convey a three-dimensional shaped object three-dimensionally shaped by the three-dimensional shaping unit, and a coloring unit configured to impart, based on the second data, the surface color to the three-dimensional shaped object conveyed by the conveyance unit.

According to the present invention, it is possible to fabricate a color three-dimensional shaped object.

In the color three-dimensional shaping apparatus described above, the data creation unit is configured to acquire, from the input data, a normal vector of a face having the surface color, specify a colorable plane of the face, based on the normal vector, and create the second data representing a transfer image planarly developed on the plane, and the coloring unit includes a print head for printing the transfer image based on the second data and is configured to transfer the printed transfer image to the three-dimensional shaped object.

According to the present invention, it is possible to color a face of the three-dimensional shaped object. In this case, a plurality of the faces of the three-dimensional shaped object can be efficiently colored by specifying a colorable plane for a plurality of the faces as the plane.

In the color three-dimensional shaping apparatus described above, the plane is a colorable plane for a plurality of the faces.

According to the present invention, it is possible to efficiently color a plurality of the faces of the three-dimensional shaped object.

In the color three-dimensional shaping apparatus described above, the coloring unit is configured to color the three-dimensional shaped object by water pressure transfer technology.

According to the present invention, it is possible to easily color the three-dimensional shaped object even when a surface has a curved profile.

In the color three-dimensional shaping apparatus described above, the coloring unit includes a transfer member which is deformable along the surface of the three-dimensional shaped object, and is to be printed with the transfer image, based on the second data, and is configured to bring the transfer member and the three-dimensional shaped object into contact with each other to transfer the transfer image to the three-dimensional shaped object.

According to the present invention, it is possible to easily color an inner surface of a recessed area and the like on the three-dimensional shaped object.

In the color three-dimensional shaping apparatus described above, the conveyance unit is configured to rotate the three-dimensional shaped object.

According to the present invention, it is possible to set an orientation of the three-dimensional shaped object in a suitable direction in each of the three-dimensional shaping unit and the coloring unit. In addition, it is possible to perform coloring on both the inner and outer surfaces.

The color three-dimensional shaping apparatus further includes a control unit that causes the three-dimensional shaping to be interrupted in a middle of the three-dimensional shaping by the three-dimensional shaping unit, causes the conveyance unit to convey the three-dimensional shaped object, causes the coloring unit to color the three-dimensional shaped object, then causes the conveyance unit to convey the three-dimensional shaped object, and causes the three-dimensional shaping to be resumed.

According to the present invention, it is possible to easily fabricate the color three-dimensional shaped object by coloring the inside and the like.

In the color three-dimensional shaping apparatus described above, the control unit causes the three-dimensional shaping by the three-dimensional shaping unit to be interrupted in the middle, causes the conveyance unit to convey the three-dimensional shaped object, and causes the coloring unit to color a predetermined face of the three-dimensional shaped object when the predetermined face becomes colorable.

According to the present invention, it is possible to color a face that becomes colorable in the middle of the three-dimensional shaping.

In the color three-dimensional shaping apparatus described above, the predetermined face is a face where coloring is difficult after the three-dimensional shaping of the 3D object, and the predetermined face includes an inner surface of the 3D object.

According to the present invention, it is possible to easily color the inner surface in the middle of the three-dimensional shaping.

In the color three-dimensional shaping apparatus described above, the control unit is configured to perform search processing for searching the predetermined face based on the input data, when the predetermined face is not searched, does not cause the three-dimensional shaping by the three-dimensional shaping unit to be interrupted.

According to the present invention, it is possible to rapidly terminate the three-dimensional shaping.

In the color three-dimensional shaping apparatus described above, in the search processing, the control unit, based on the input data, is configured to obtain respective normal vectors of parts having colors in the 3D object, determine whether or not each of normal vectors collide with another part of the 3D object, and detect a face having the part including a colliding normal vector as the predetermined face.

According to the present invention, it is possible to search the inner surface where coloring is difficult after the three-dimensional shaping with high accuracy.

In the color three-dimensional shaping apparatus described above, the coloring unit is configured to flatten the surface of the three-dimensional shaped object conveyed by the conveyance unit and form a surface layer imparted, based on the second data, with the surface color, for the three-dimensional shaped object.

According to the present invention, it is possible to easily fabricate the color three-dimensional shaped object by reducing surface unevenness.

In the color three-dimensional shaping apparatus described above, the surface layer flattens a step generated between the layers of the three-dimensional shaping unit.

According to the present invention, it is possible to fabricate the color three-dimensional shaped object by reducing surface unevenness while using a laminate type three-dimensional shaping unit.

In the color three-dimensional shaping apparatus described above, the coloring unit is configured to impart the surface layer on the three-dimensional shaped object by water pressure transfer technology.

According to the present invention, it is possible to easily color the three-dimensional shaped object even when the surface has a curved profile.

In the color three-dimensional shaping apparatus described above, the surface layer has a multilayered structure, any layer of which is a color layer having been colored based on the second data.

According to the present invention, it is possible to obtain an effect of improving color development and the like by a layer other than the color layer.

In the color three-dimensional shaping apparatus described above, the surface layer has a transparent clear layer provided on the opposite side of the three-dimensional shaped object with respect to the color layer.

According to the present invention, it is possible to protect the color layer and easily obtain surface glossiness.

In the color three-dimensional shaping apparatus described above, the surface layer is provided on a side of the three-dimensional shaped object with respect to the color layer and has a layer contributing to color development of the color layer.

According to the present invention, it is possible to improve color development, expand a color reproduction gamut, suppress influence of a color of a material of the three-dimensional shaped object, and easily reproducing a metal glass texture.

In the color three-dimensional shaping apparatus described above, the surface layer is formed of a curable resin, and the coloring unit is configured to primarily cure a transfer image before transferring to the three-dimensional shaped object within a transferable range and secondarily cure the transfer image transferred to the three-dimensional shaped object.

According to the present invention, it is possible to more easily obtain the surface layer capable of flattening the surface of the three-dimensional shaped object.

According to another aspect of the present invention, there is provided a method for controlling a color three-dimensional shaping apparatus, the method including acquiring data on a 3D object as input data using a data acquisition unit, creating, from the input data, first data regarding shapes of layers obtained by dividing the 3D object into multiple layers and second data regarding a surface color of the 3D object using a data creation unit, three-dimensionally shaping the 3D object, based on the first data using the three-dimensional shaping unit, conveying a three-dimensional shaped object three-dimensionally shaped by the three-dimensional shaping unit using a conveyance unit, and coloring the surface of the conveyed three-dimensional shaped object, based on the second data using the coloring unit.

According to the present invention, it is possible to easily fabricate a color three-dimensional shaped object.

In the method for controlling described above, the coloring unit is configured to color the three-dimensional shaped object by water pressure transfer technology.

According to the present invention, it is possible to easily color the three-dimensional shaped object even when the surface has a curved profile.

According to the present invention, in the method for controlling described above, the coloring unit is configured to bring a transfer member which is deformable along the surface of the three-dimensional shaped object and is to be printed with a transfer image based on the second data, and the three-dimensional shaped object, into contact with each other to transfer the transfer image to the three-dimensional shaped object.

According to the present invention, it is possible to easily color an inner surface of a recessed area and the like on the three-dimensional shaped object.

The method for controlling described above further includes interrupting the three-dimensional shaping in a middle of the three-dimensional shaping using the three-dimensional shaping unit, and causing the conveyance unit to convey the three-dimensional shaped object, causing the coloring unit to color the three-dimensional shaped object, based on the second data, and then causing the conveyance unit to convey the three-dimensional shaped object to resume the three-dimensional shaping.

According to the present invention, it is possible to easily fabricate the color three-dimensional shaped object by coloring the inside and the like.

In the method for controlling described above, interrupting the three-dimensional shaping in the middle of the three-dimensional shaping includes interrupting the three-dimensional shaping when a predetermined face of the three-dimensional shaped object becomes colorable.

According to the present invention, it is possible to color a face that becomes colorable in the middle of the three-dimensional shaping.

In the method for controlling described above, the predetermined face is a face where coloring is difficult after the three-dimensional shaping of the 3D object, and includes an inner surface of the 3D object.

According to the present invention, it is possible to easily color the inner surface in the middle of the three-dimensional shaping.

In the method for controlling described above, the coloring unit is configured to flatten the surface of the conveyed three-dimensional shaped object and form a surface layer by coloring the surface, based on the second data for the conveyed three-dimensional shaped object.

According to the present invention, it is possible to easily fabricate the color three-dimensional shaped object by reducing surface unevenness.

In the method for controlling described above, the coloring unit is configured to impart the surface layer on the three-dimensional shaped object by water pressure transfer technology.

According to the present invention, it is possible to easily color the three-dimensional shaped object even when the surface has a curved profile.

In the method for controlling described above, the surface layer is formed of a curable resin, and the coloring unit is configured to primarily cure a transfer image before transferring to the three-dimensional shaped object within a transferable range and secondarily cure the transfer image transferred to the three-dimensional shaped object.

According to the present invention, it is possible to more easily obtain the surface layer capable of flattening the surface of the three-dimensional shaped object.

### BRIEF DESCRIPTION OF DRAWINGS

FIG. 1 is a block diagram illustrating a color three-dimensional shaping apparatus according to a first exemplary embodiment of the present invention.

FIG. 2 is a diagram schematically illustrating data contents of 3D data.

FIG. 3 is a diagram schematically illustrating a configuration of a coloring unit.

FIG. 4 is a diagram illustrating a state in which the three-dimensional shaped object is moved downward.

FIG. 5 is a diagram illustrating a transferred three-dimensional shaped object.

FIG. 6 is a flowchart illustrating a basic operation of a shaping apparatus.

FIG. 7 is a flowchart illustrating a colorable face specifying process.

FIG. 8 is a diagram for describing a colorable face specifying process.

FIG. 9 is a diagram for describing a colorable face specifying process.

FIG. 10 is a diagram for describing a colorable face specifying process.

FIG. 11 is a perspective view illustrating a recessed 3D object according to a second exemplary embodiment.

FIG. 12 is a diagram schematically illustrating a configuration of a coloring unit.

FIG. 13 is a cross-sectional view illustrating a 3D object internally including a cavity portion according to a third exemplary embodiment.

FIG. 14 is a flowchart illustrating search processing.

FIG. 15 is a diagram illustrating a 3D object and a transfer tank of FIG. 13.

FIG. 16 is a flowchart illustrating a coloring process according to a fourth exemplary embodiment.

FIG. 17 is a diagram illustrating a transfer tank and a three-dimensional shaped object before being transferred.

FIG. 18 is a diagram illustrating a transfer tank and a three-dimensional shaped object after being transferred.

FIG. 19 is a flowchart illustrating a coloring process according to a fifth exemplary embodiment.

FIG. 20 is a diagram illustrating an exemplary surface layer of a multilayered structure according to a sixth exemplary embodiment.

FIG. 21 is a diagram for describing a modification.

### DESCRIPTION OF EMBODIMENTS

Embodiments of the present invention will now be described with reference to the accompanying drawings.

### First Exemplary Embodiment

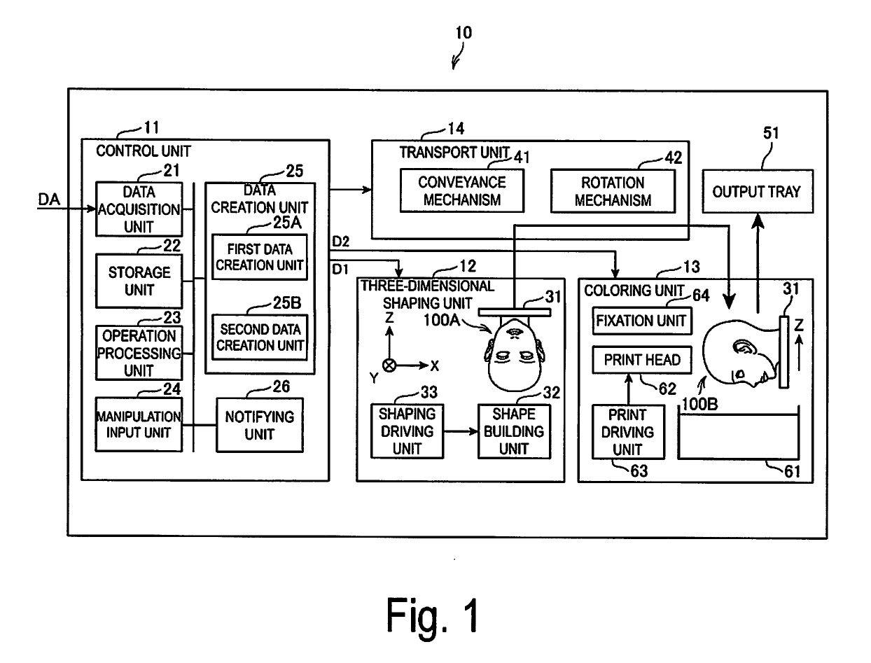

FIG. 1 is a block diagram illustrating a color three-dimensional shaping apparatus according to an exemplary embodiment of the resent invention.

The color three-dimensional shaping apparatus (hereinafter, referred to as a shaping apparatus) 10 includes a control unit 11, a three-dimensional shaping unit 12, a coloring unit 13, and a conveyance unit 14. The shaping apparatus 10 is an apparatus in which the three-dimensional shaping unit 12 shapes a three-dimensional shaped object, the conveyance unit 14 conveys the three-dimensional shaped object to the coloring unit 13, and the coloring unit 13 colors the three-dimensional shaped object under control of the control unit 11.

In the following description, the three-dimensional shaped object will be denoted by reference numeral 100A when it is placed in the three-dimensional shaping unit 12, and will be denoted by reference numeral 100B when it is placed in the coloring unit 13. In addition, the three-dimensional shaped object will be denoted by reference numeral 100 when it is referred to regardless of the position.

The control unit 11 is a portion for controlling each part of the shaping apparatus 10 and includes a data acquisition unit 21, a storage unit 22, an operation processing unit 23, a manipulation input unit 24, a data creation unit 25, and a notifying unit 26. The data acquisition unit 21 is an interface for obtaining 3D object data (hereinafter, referred to as “3D data”) DA as input data. The data acquisition unit 21 acquires the 3D data DA from an external device such as a personal computer and the like or an external storage medium directly or via a communication network such as the Internet and the like.

Here, the 3D object represents a solid article and is also referred to as a “three-dimensional object” or “3D object model”. The 3D object has a surface color. The color is also referred to as “texture” including its classification, a pattern such as a line or a figure, and characters.

The 3D data DA is data obtained by expressing a solid article in format known in the art such as STL, OBJ, and IGE and the like and is created using three-dimensional computer graphics (3D CO) or three-dimensional CAD software. In addition, the color of the 3D object is information addable to the 3D data DA using such a software program.

In a case where the 3D data DA is, for example, a STL format file, the 3D data DA expresses a solid body by a set of polygonal shapes (corresponding to polygons) having three peaks (coordinates). Herein, the coordinate value means a coordinate value in a coordinate system defined by three axes perpendicular to each other. The polygon includes, for example, a triangle. In addition, each polygon has a face normal vector, and a direction of each face normal vector represents a direction in which the surface of the solid body faces.

The storage unit 22 stores various types of data, programs, and the like, processed by the shaping apparatus 10. This storage unit 22 includes, for example, a hard disk drive (HDD), a solid-state drive (SSD), and the like.

The operation processing unit 23 serves as a microcomputer (micom) that controls each part of the shaping apparatus 10 by executing a program stored in the storage unit 22. More specifically, the operation processing unit 23 includes a microcomputer, a system-on-a-chip (SOC), a central processing unit (CPU), and the like.

The manipulation input unit 24 receives a user instruction input through an input device such as a keyboard and the like and outputs a signal corresponding to the user instruction to the operation processing unit 23. As a result, the operation processing unit 23 performs various types of processing, based on the user instruction. The notifying unit 26 is a device for informing various types of information to a user and has, for example, a display function for displaying various types of information, and a sound output function for informing various types of sound, and the like.

The data creation unit 25 is a block for performing a data conversion process for the 3D data DA obtained by the data acquisition unit 21 under control of the operation processing unit 23. The data creation unit 25 includes a first data creation unit 25A and a second data creation unit 25B.

The first data creation unit 25A performs a data conversion process for obtaining, from the 3D data DA, first data D1 regarding a shape of each layer when the 3D object is divided into multiple layers. In addition, the second data creation unit 25B performs a data conversion process for obtaining second data D2 regarding color of the 3D object, from the 3D data DA.

This data conversion process will be described by way of example.

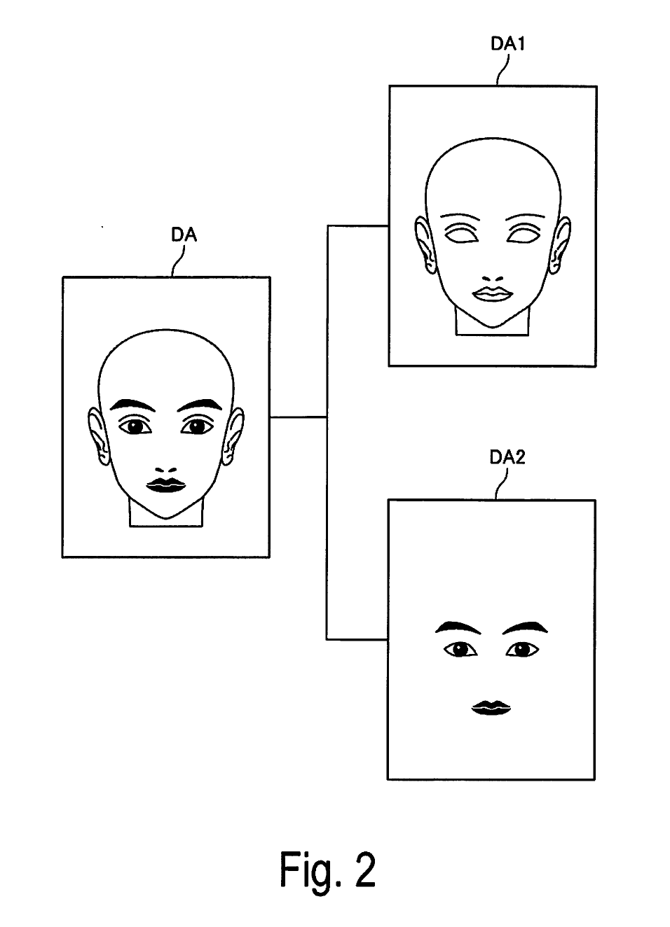

FIG. 2 is a diagram schematically illustrating data contents of the 3D data DA. Note that the 3D data DA of FIG. 2 represents a head portion of a human being. The 3D data DA includes shape data DA1 representing a shape of the head portion (corresponding to the 3D object) and color data DA2 representing color of the head portion, that is, the color data DA2 representing colors of eyes, eyebrows, and lips. Since a background color of the three-dimensional shaped object is employed as a color of skin, the color of skin is not included in the color data DA2. However, in a case where the color of skin is different from the background color, it may be included in the color data DA2. Note that the color data DA2 is also referred to as “texture data”.

The first data creation unit 25A extracts the shape data DA1 from the 3D data DA and acquires cross-sectional shapes of each layer obtained by dividing the head portion into multiple layers, based on the shape data DA1 through computation. Each of the two-dimensional data representing the cross-sectional shapes of each layer is included in the first data D1. Note that the first data D1 is also referred to as “slice data”.

In the case of the 3D data DA of the head portion, a plurality of first data D1 representing the cross-sectional shapes are created at every predetermined slice width in a vertical direction of the head portion. The slice widths may be within a range where the thickness of each layer is suitable for lamination by the three-dimensional shaping unit 12, and don't need to be consistent. As a result, the first data D1 for three-dimensional shaping is created in the three-dimensional shaping unit 12.

The second data creation unit 25B extracts the color data DA2 from the 3D data DA and converts the image corresponding to the color data DA2 into an image planarly developed on a transfer surface of the coloring unit 13. The data representing the image subjected to this conversion is the second data D2. Since the coloring unit 13 transfers a transfer image through water pressure transfer, the transparent surface is a water surface.

That is, the second data creation unit 25B creates a transfer image by which an image corresponding to the color data DA2 can be transferred through the water pressure transfer into the 3D object expressed by the shape data DA1 and creates data representing this transfer image as the second data D2. As a result, the second data D2 for performing the water pressure transfer in the coloring unit 13 is created. Various conversion processes known in the art are applicable to the data conversion processes for the first data creation unit 25A and the second data creation unit 25B.

The three-dimensional shaping unit 12 is a drag-up building type. As the shaping progresses, the three-dimensional shaped object 100A is moved upward by the conveyance unit 14. In FIG. 1 and subsequent drawings, X, Y, and Z axes are spatial axes for defining a direction of the shaping apparatus 10. More specifically, the X, Y, and Z axes are three axes perpendicular to each other. The Z axis extends in a vertical direction (Z direction), and the −Z direction is a vertical downward direction and +Z direction is a vertical upward direction. In addition, a face normal to the Z axis is an XY plane, which is in parallel with the water surface.

The three-dimensional shaping unit 12 is operated in connection with the conveyance unit 14 under control of the control unit 11 to function as a photo fabrication type laminate shaping apparatus. The three-dimensional shaping unit 12 includes a stage 31 serving as a work plane for shaping the three-dimensional shaped object 100A, a shape building unit 32 that deposits each layer of the three-dimensional shaped object on the stage 31, and a shaping driving unit 33 that drives the shape building unit 32.

In the three-dimensional shaping unit 12, a bottom face of the stage 31 is a work plane, and the work plane is coplanar with the XY plane. The stage 31 is movable upward and downward along the Z axis, and movable or rotatable toward the coloring unit 13 and the like using the conveyance unit 14.

The shape building unit 32 irradiates shaping material with light inside a resin tub (not illustrated) placed under the stage 31. The shaping material is photocurable resin that can be cured by light. As a result, a portion that receives the irradiated light in the shape building unit 32 is cured. The shaping driving unit 33 controls an irradiation position of the shape building unit 32 and the like under control of the operation processing unit 23 of the control unit 11.

The three-dimensional shaping unit 12 forms shapes of each layer (unit layer) using the shape building unit 32, based on the first data D1 regarding the shapes of each layer obtained by dividing the 3D object. Then, the three-dimensional shaping unit 12 forms the next unit layer by lifting the stage 31 in the +Z direction by a thickness of the unit layer. As a result, a three-dimensional shaped object 100A corresponding to the 3D object is shaped.

Since the drag-up building type is employed, it is possible to easily increase a vertical movement length of the stage 31. In addition, since the stage 31 is easily moved independently from other parts of the three-dimensional shaping unit 12, it is possible to easily implement a part for moving the stage 31 toward the coloring unit 13 and the like. Note that configurations of three-dimensional printers known in the art may be widely employed in the photo fabrication type and the drag-up building type. In addition, the three-dimensional shaping unit 12 is not limited to the aforementioned configuration, any three-dimensional printer known in the art such as a fused laminate modeling type, a powder sintering type, and an inkjet type and the like may be employed.

The conveyance unit 14 includes a conveyance mechanism 41 and a rotation mechanism 42. The conveyance mechanism 41 is a mechanism for conveying the three-dimensional shaped object 100 using the stage 31 and capable of conveying the three-dimensional shaped object 100 to the three-dimensional shaping unit 12, the coloring unit 13, the output tray 51, and the like.

The rotation mechanism 42 is a mechanism for rotating the three-dimensional shaped object 100 using the stage 31 and capable of rotating the three-dimensional shaped object 100 in any direction. Using the rotation mechanism 42, it is possible to change a posture of the three-dimensional shaped object 100 to direct a transfer target face (corresponding to the colorable face) downward when the coloring unit 13 performs water pressure transfer. Since the conveyance unit 14 conveys and rotates the three-dimensional shaped object 100 using the first data D1 regarding the shape and the second data D2 regarding the color created from the 3D data DA, it is possible to perform positioning with high accuracy when the coloring unit 13 performs the water pressure transfer.

For example, a rail mechanism is employed in the conveyance mechanism 41, and a rotary table mechanism is employed in the rotation mechanism 42. Mechanisms known in the art may be widely employed in the conveyance mechanism 41 and the rotation mechanism 42. In addition, a multi-axial robot arm may be employed so that the same robot arm is shared between the conveyance mechanism 41 and the rotation mechanism 42.

Next, the coloring unit 13 will be described.

The coloring unit 13 is operated in connection with the conveyance unit 14 under control of the control unit 11 to function as a water pressure transfer device for coloring the three-dimensional shaped object 100B using the water pressure transfer technology.

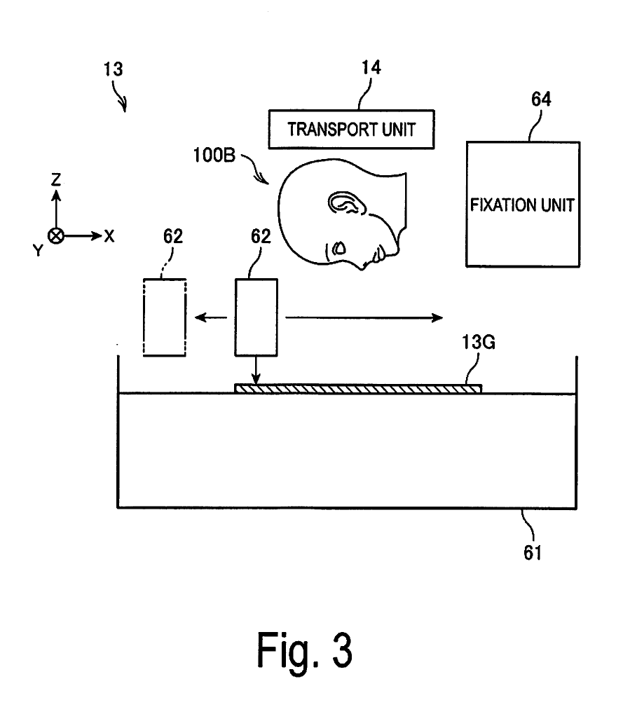

FIG. 3 is a diagram schematically illustrating the configuration of the coloring unit 13.

As illustrated in FIGS. 1 and 3, the coloring unit 13 includes a transfer tank 61, a print head 62, a print driving unit 63, and a fixation unit 64. The transfer tank 61 is opened upward and contains water (liquid) inside. A thickener and the like may be mixed in the contained water. Alternatively, instead of the water, a high-density liquid may be employed.

The print head 62 is an inkjet type print head that discharges ink with a plurality of colors toward the water surface of the transfer tank 61 by fragmenting the ink into minute droplets. This ink is cured by light such as ultraviolet rays. That is, the ink is photocurable. In addition, the ink particles may include oleaginous ink particles or ink particles coated with a hydrophobic protection layer. Note that the ink is not limited to the photocurable ink, and a wide variety of known inks suitable for water pressure transfer may be employed.

The print driving unit 63 performs a discharge control for the print head 62 and a movement control for the print head 62 (in FIG. 3, the movement in the X direction is indicated by an arrow) as drive operations of the print head 62 under control of the operation processing unit 23 of the control unit 11. The print driving unit 63 prints the image corresponding to the second data D2 on the water surface of the transfer tank 61 by driving the print head 62, based on the second data D2. Note that, in FIG. 3, reference numeral 13G denotes a transfer image printed on the water surface.

In a case where the print head 62 is configured to discharge ink across the entire width (length in the Y direction) of the transfer tank 61, the print head 62 may be configured to move in the X direction. In addition, in a case where the print head 62 is configured to have a small size and not to discharge ink across the entire width (length in the Y direction) of the transfer tank 61, the print head 62 may be configured to move in both the X direction and the Y direction.

The print driving unit 63 may move the print head 62 to a retreated position distant from the transfer image 130 (position indicated by the two-dotted chain line in FIG. 3) by moving the print head 62 toward the left in FIG. 3.

Note that, the coloring unit 13 is not limited to the configuration where the printing is performed by using water (water surface) as a print medium, and the printing may be performed by using a water pressure transfer film as the print medium. For example, the water pressure transfer film is floated on the water surface and is pressed to the three-dimensional shaped object 100B to transfer the image on the film to the three-dimensional shaped object 100B. Any film known in the art such as a water-soluble film or a water-swelling film and the like may be widely employed as the water pressure transfer film.

The control unit 11 controls the conveyance unit 14 using the position information of the printed image. As illustrated in FIG. 3, the conveyance unit 14 may move the three-dimensional shaped object 100B to a position above the transfer tank 61 and move the three-dimensional shaped object 100B down toward the transfer tank 61 from the position. That is, the conveyance unit 14 functions as a lift mechanism for lowering or lifting the three-dimensional shaped object 100B in the coloring unit 13. In addition, the conveyance unit 14 rotates the three-dimensional shaped object 100B to a direction suitable for the transfer using the rotation mechanism 42. In FIG. 3, the orientation of the three-dimensional shaped object 100B is changed by 90° from the direction used in the shaping of the three-dimensional shaping unit 12 to direct a face of the three-dimensional shaped object downward.

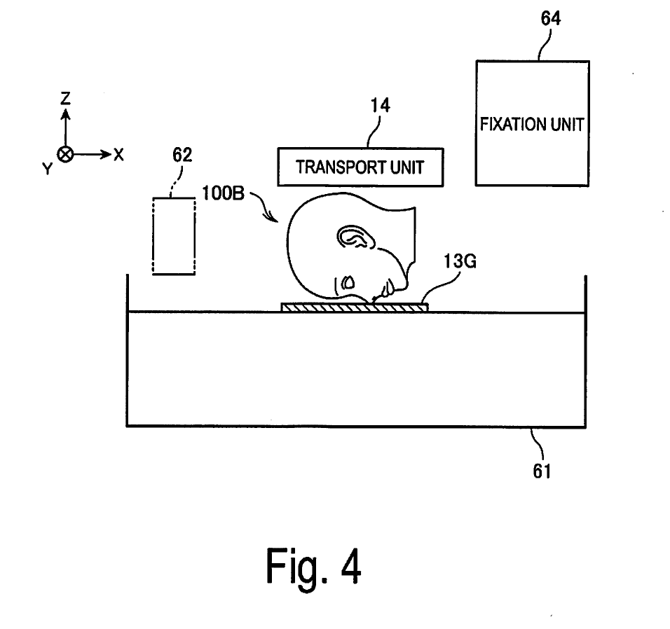

FIG. 4 illustrates a state in which the three-dimensional shaped object 100B is moved downward. The three-dimensional shaped object 100B is immersed to the water surface including the transfer image 130 by moving the three-dimensional shaped object 100B downward. That is, the three-dimensional shaped object 100B is moved to the transfer position.

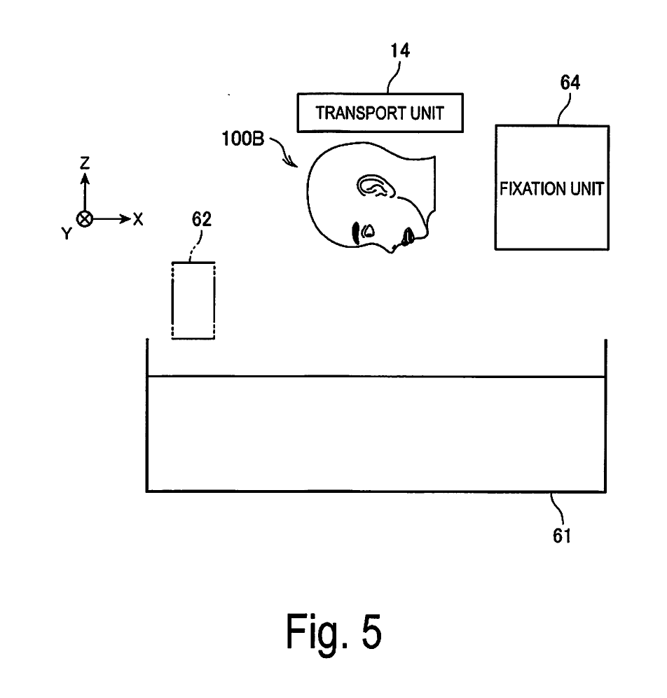

FIG. 5 is a diagram illustrating the three-dimensional shaped object 100B subjected to the transfer. The three-dimensional shaped object 100B subjected to the transfer is moved upward using the conveyance unit 14, and the fixation unit 64 performs a fixation process for fixing the transfer image 13G.

The fixation unit 64 irradiates ultraviolet rays (light) onto the three-dimensional shaped object 100B to cure the ink of the print image as the fixation process. Note that, as the fixation process, in a case where the ink is not photocurable and the like, the fixation unit 64 blows the hot air to the three-dimensional shaped object 100B for drying and fixing the ink. An overcoat such as clear ink and the like may be coated. Note that any process known in the art may be employed as the fixation process depending on the ink.

Subsequently, the operation of the shaping apparatus 10 will be described.

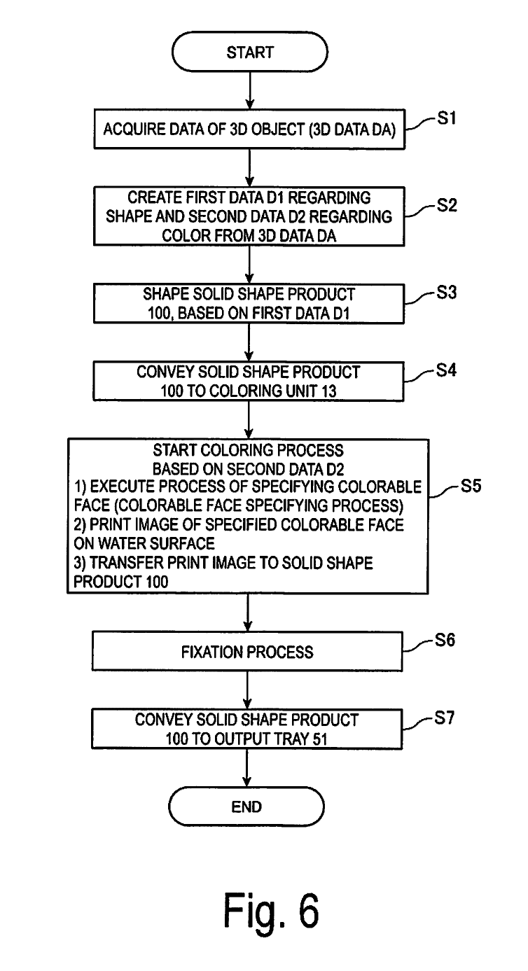

FIG. 6 is a flowchart illustrating a basic operation of the shaping apparatus 10.

First, the operation processing unit 23 of the control unit 11 acquires the 3D data DA as input data (step S1). Next, the operation processing unit 23 causes the first data creation unit 25A of the data creation unit 25 to create the first data D1 regarding the shape from the 3D data DA and causes the second data creation unit 25B to create second data D2 regarding the color from the 3D data DA (step S2).

The operation processing unit 23 causes the three-dimensional shaping unit 12 to shape the three-dimensional shaped object 100, based on the first data D1 by outputting the first data D1 to the three-dimensional shaping unit 12 (step S3).

As the shaping of the three-dimensional shaped object 100 is completed, the operation processing unit 23 conveys the three-dimensional shaped object 100 to the coloring unit 13 using the conveyance unit 14 (step S4) and initiates the coloring process based on the second data D2 (step S5). In this coloring process, the operation processing unit 23 performs a process of specifying a face (hereinafter, referred to as a “colorable face”) for collectively coloring a plurality of faces of the three-dimensional shaped object 100 (colorable face specifying process). Then, the operation processing unit 23 performs a process of printing an image of the specified colorable face (corresponding to the transfer image) on a water surface serving as the transfer surface and a process of transferring the printed transfer image to the three-dimensional shaped object 100. The colorable face specifying process will be described below in more details.

After transferring to the three-dimensional shaped object 100, the operation processing unit 23 moves the three-dimensional shaped object 100 to a fixation position using the conveyance unit 14 and performs a fixation process using the fixation unit 64 (step S6). As the fixation process is terminated, the operation processing unit 23 conveys the three-dimensional shaped object 100 to the output tray 51 (FIG. 1) using the conveyance unit 14.

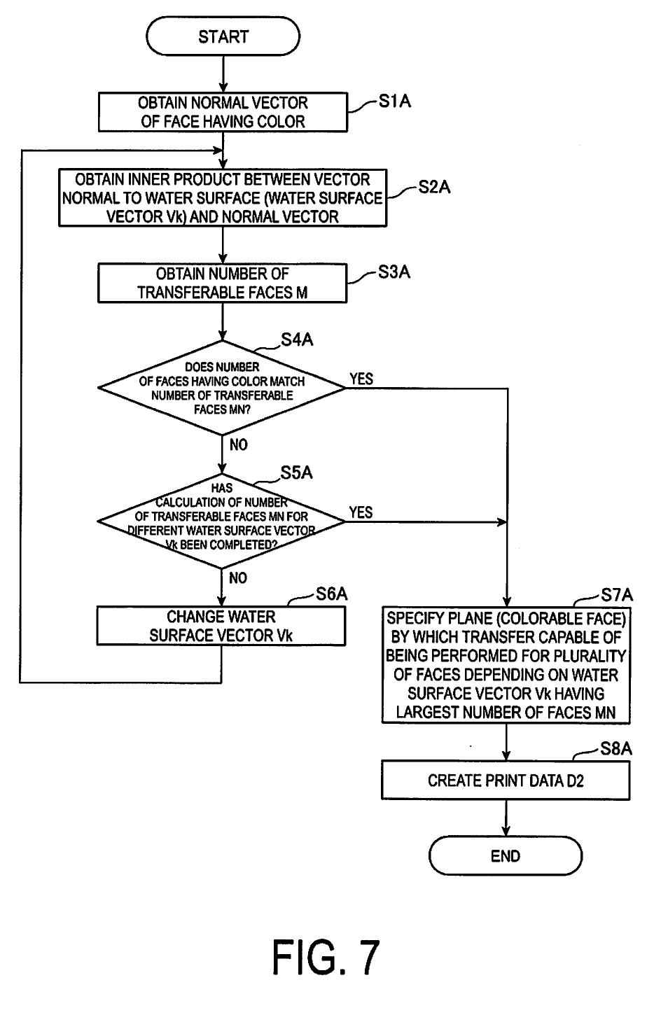

FIG. 7 is a flowchart illustrating the colorable face specifying process.

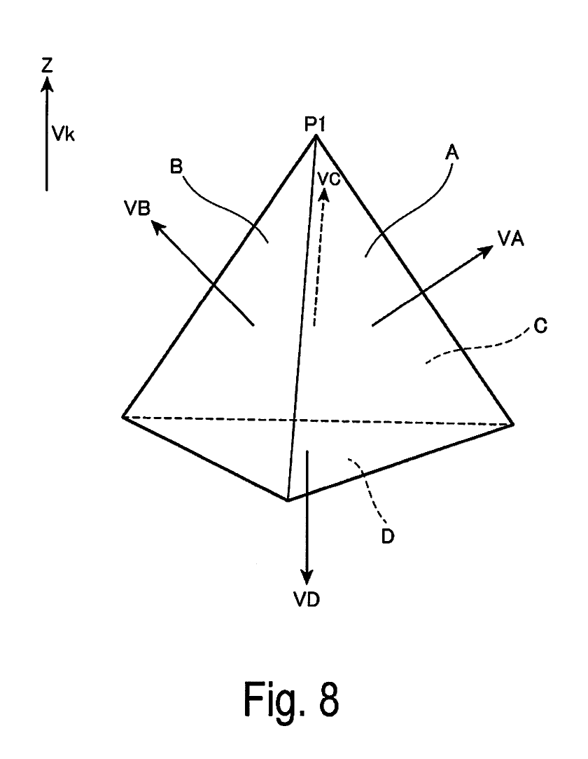

In the colorable face specifying process, when a plurality of faces have color on the 3D object, a plane which is capable of collectively performing the water pressure transfer for a plurality of faces is specified as the colorable face. Here, FIGS. 8 to 10 are diagrams for describing the colorable face specifying process.

FIGS. 8 to 10 illustrate cases where the 3D object (three-dimensional shaped object 100) is a trigonal pyramid having four faces A, B, C, and D, the faces A, B, and C have color, and the face D does not have color.

First, the operation processing unit 23 obtains normal vectors of each face having color (corresponding to the face normal vectors indicated by the arrows VA, VB, and VC in FIGS. 8 to 10), based on the 3D data DA (step S1A of FIG. 7). Note that, since the face D does not have color, a normal vector may not be provided for the face D (indicated by the arrow VD in FIG. 8 and the like).

In a case where the face is included in the 3D data DA, the normal vector may be obtained from the 3D data DA. In a case where the face is not included in the 3D data DA, the normal vector may be calculated, based on coordinate information included in the 3D data DA.

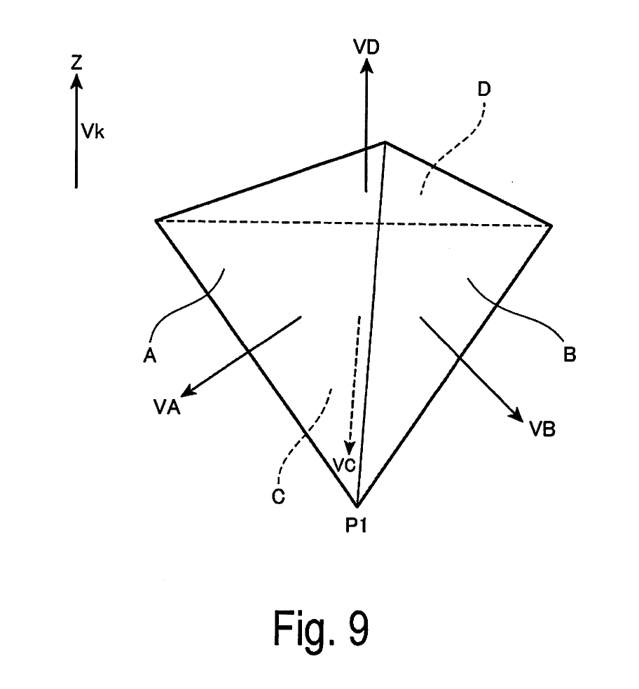

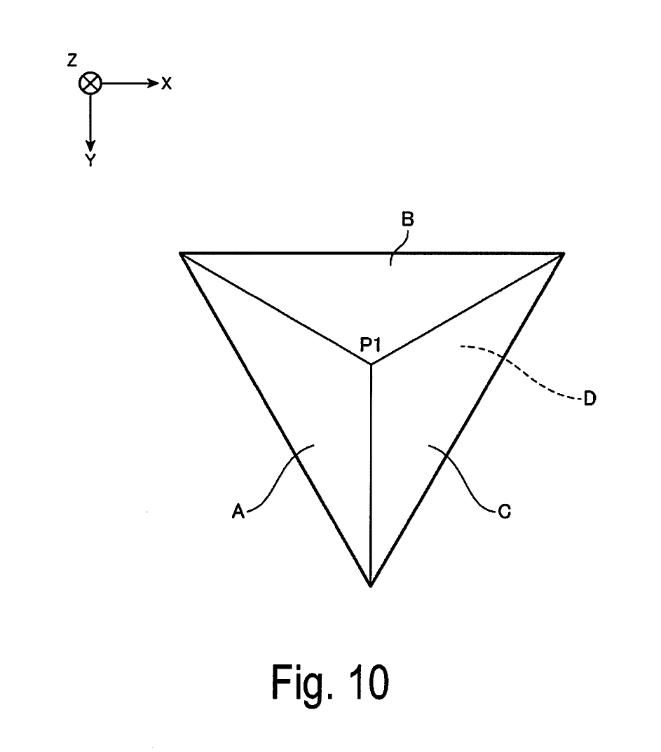

Next, the operation processing unit 23 sets a water surface vector Vk normal to the water surface serving as a transfer surface and obtains inner products between the water surface vector Vk and each normal vector VA, VB, and VD (step S2A in FIG. 7). In FIG. 8, it is assumed that the water surface vector Vk is set such that a peak P1 common to the faces A, B, and C of the trigonal pyramid (three-dimensional shaped object 100) is directed in the +Z direction. In addition, in FIG. 9, it is assumed that the water surface vector Vk is set such that the peak P1 is directed in the −Z direction. In addition, FIG. 10 is a view of FIG. 9 as seen from the downside.

An inner product of vectors is a scalar amount indicating how close the two vectors are positioned. Therefore, assuming that each of normal vectors VA to VD is a unit vector, a codirectional probability increases as the inner product increases.

In a case where the two vectors are codirectional, the faces are collectively transferable faces. Therefore, it is possible to determine whether or not the two faces are collectively transferable faces, based on the value of the inner product of the vectors.

The operation processing unit 23 obtains the number MN of the collectively transferable surfaces out of the faces A, B, and C having color by performing this determination (step S3A in FIG. 7). In the case of FIG. 8, the faces A, B, and C are not transferable. In the case of FIG. 9, since the three faces A, B, and C are transferable, the transfer is collectively performed for the entire faces having colors.

In a case where the number of faces having color does not match the number MN of transferable faces (step S4A: NO), the operation processing unit 23 performs the next process unless the number MN of the transferable faces is calculated for a different water surface vector Vk (where k=1 to n, and “n” is an integer) (step SSA: YES).

In this case, the operation processing unit 23 performs the process of steps S2A to S4A by changing the water surface vector Vk to a different vector (step S6A). As a result, in a case where the number of faces having color does not match the number MN of transferable faces, the number MN of the transferable faces is calculated for each of different water surface vectors V1 to Vn.

Meanwhile, in a case where the number of faces having color matches the number MN of the transferable faces (step S4A: YES), the operation processing unit 23 completes the coloring by performing the water pressure transfer operation once. Therefore, the process advances to step S7A. In addition, the process advances to step S7A in a case where the operation processing unit 23 completely calculates the number MN of transferable faces for the entire different water surface vectors Vk (step S5A: YES).

In the process of step S7A, the operation processing unit 23 specifies a plane (colorable face) for performing the transfer for a plurality of faces based on the water surface vector Vk having the largest number MN of faces. Subsequently, the operation processing unit 23 allows the second data creation unit 25B to create print data for printing the transfer image planarly developed on the transfer surface as the second data D2 (step S8A).

For example, in the case of the trigonal pyramid (three-dimensional shaped object 100) described above, the second data D2 for printing the transfer image which allows for transferring of the faces A, B, and C illustrated in FIG. 10 at a time is created. As a result, the second data D2 is created such that a plurality of faces having color in the 3D object are collectively transferred. Hereinbefore, the colorable face specifying process has been described.

Alternatively, although it is assumed that the colorable face specifying process is performed in cooperation with the operation processing unit 23 and the second data creation unit 25B in the aforementioned case, the second data creation unit 25B may independently perform the colorable face specifying process without a limitation.

After the colorable face specifying process, the operation processing unit 23 outputs the second data D2 to the coloring unit 13 and adjusts the orientation of the three-dimensional shaped object 100 to be suitable for the transfer using the conveyance unit 14, so that the coloring unit 13 performs coloring (process of transferring and fixing the image). Note that, in a case where it is difficult to color the entire faces having color through one transfer operation, the operation processing unit 23 executes the colorable face specifying process for the remaining faces and efficiently performs the coloring for the remaining faces. Through the colorable face specifying process, it is possible to reduce the number of the transfer operations. Therefore, time can be saved.

As described above, the shaping apparatus 10 according to this embodiment acquires 3D data DA representing a 3D object using the data acquisition unit 21 as input data and creates, by the data creation unit 25, the first data D1 regarding shape, and second data D2 regarding a surface color of the 3D object from the 3D data DA. Then, the shaping apparatus 10 performs three-dimensional shaping of the 3D object, based on the first data D1 using the three-dimensional shaping unit 12, conveys the three-dimensional shaped object 100 subjected to the three-dimensional shaping using the conveyance unit 14, and colors the surface of the three-dimensional shaped object 100, based on the second data D2 using the coloring unit 13. Using such a configuration and such a control method, it is possible to easily manufacture the color three-dimensional shaped object 100. Since the three-dimensional shaping and coloring are executed, based on the first data D1 regarding shape and the second data D2 regarding color created from the 3D data DA, it is possible to implement positioning with high accuracy during coloring. Therefore, it is possible to perform coloring for the three-dimensional shaped object 100 with high accuracy.

Since the coloring unit 13 colors the three-dimensional shaped object 100, based on the water pressure transfer technology, it is possible to easily color the three-dimensional shaped object 100 even when the surface has a curved profile.

The data creation unit 25 performs a colorable face specifying process in cooperation with the operation processing unit 23 or by independently using the data creation unit 25. That is, the data creation unit 25 acquires each of the normal vectors of the face having color from the 3D data DA, specifies a colorable plane of each face, and creates the second data D2 representing a transfer image planarly developed on this specified plane. As a result, it is possible to color a face of the three-dimensional shaped object 100. In this case, by specifying the colorable plane for a plurality of faces of the 3D object as the aforementioned plane, it is possible to efficiently color a plurality of faces of the three-dimensional shaped object 100.

Since the coloring unit 13 creates the transfer image using the print head 62 based on the inkjet technology, it is possible to easily create a high-quality transfer image using the print head known in the art. In addition, since the conveyance unit 14 is capable of rotating the three-dimensional shaped object 100, it is possible to change the orientation of the three-dimensional shaped object 100 in both the three-dimensional shaping unit 12 and the coloring unit 13. Therefore, it is possible to set the orientation of the three-dimensional shaped object 100 in a suitable direction in both the three-dimensional shaping unit 12 and the coloring unit 13. In addition, it is possible to color other parts by changing the orientation of the three-dimensional shaped object 100 in the coloring unit 13 even when the coloring is not completed through a single water pressure transfer operation. In this manner, by changing the orientation of the three-dimensional shaped object 100 and repeating the water pressure transfer, printing can be performed even if the three-dimensional shaped object 100 has a complicated shape. In addition, it is possible to perform coloring on both the inner and outer surfaces.

### Second Exemplary Embodiment

A second exemplary embodiment of the present invention will now be described.

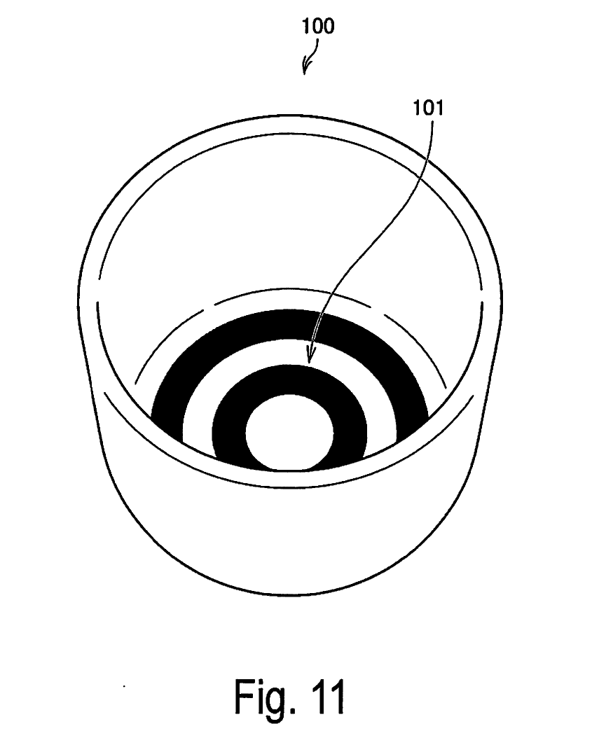

In a case where coloring for a three-dimensional shaped object is performed through water pressure transfer, transfer (coloring) is performed for an area where the three-dimensional shaped object 100 contacts water. However, in a case where the three-dimensional shaped object 100 has a recessed area where water does not enter all the way, it is difficult to transfer an image to the inner surface of the recessed area. In particular, in the case of a recessed 3D object (three-dimensional shaped object 100) of FIG. 11, it is difficult to color the bottom face (hereinafter, referred to as an “inner bottom face”) 101 located in the deepest part of the inner surface.

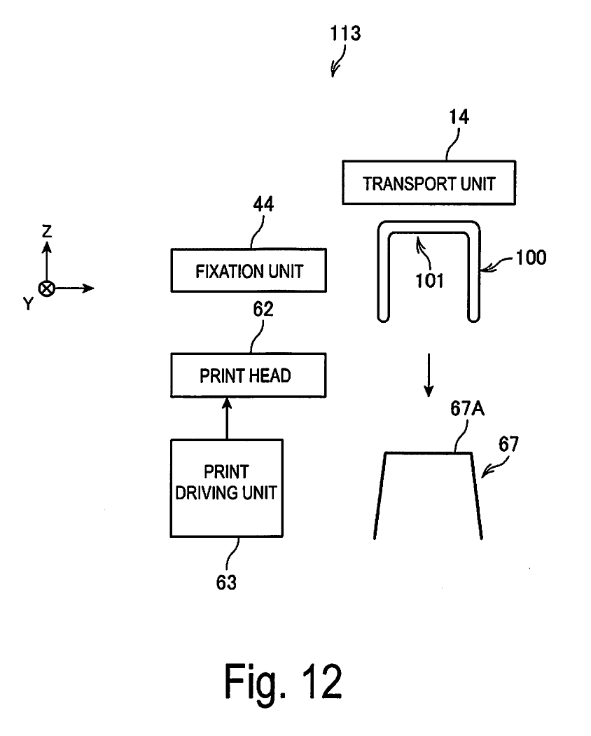

In this regard, the shaping apparatus 10 according to the second exemplary embodiment has a coloring unit 113 (FIG. 12) that is capable of coloring the inner bottom face 101 instead of the coloring unit 13. Note that, except for the coloring unit 113, the configuration is similar to the configuration of the first exemplary embodiment. The different parts will now be described in detail.

FIG. 11 is a perspective view illustrating a recessed 3D object according to the second exemplary embodiment. FIG. 12 is a diagram schematically illustrating the configuration of the coloring unit 113.

The coloring unit 113 is a device for coloring the three-dimensional shaped object 100, based on the stamp print technology and includes a transfer member 67 functioning as a stamp, a print head 62, a print driving unit 63, and a fixation unit 64.

The transfer member 67 has a planar transfer surface 67A. The transfer surface is flexible to follow various unevenness on the three-dimensional shaped object 100, and is air-permeable. For example, the transfer member 67 may be formed of sponge, rubber, and the like. In the example of FIG. 12, the transfer member 67 has one end face (transfer surface) 67A located in the upper end and formed in a circular shape, and has a truncated conical shape whose diameter increases toward the other end side which is the lower side as seen in a side view. However, the shape of the transfer member 67 may be changed appropriately.

The print head 62 is an inkjet type in which ink having a plurality of colors is atomized and discharged into the transfer surface 67A of the transfer member 67. A wide variety of inks known in the art and suitable for stamp printing may be employed as the ink. In addition, a photocurable ink cured by light such as ultraviolet rays and the like may be employed as the ink as in the first exemplary embodiment.

The print driving unit 63 performs a discharge control of the print head and a movement control of the print head 62 to drive the print head 62 under control of the operation processing unit 23. The print driving unit 63 prints an image corresponding to the second data D2 on the transfer surface 67A of the transfer member 67 by driving the print head 62, based on the second data D2.

The fixation unit 64 performs a curing process to the ink transferred to the three-dimensional shaped object 100. For example, the fixation unit 64 performs a process of curing the ink by irradiating light or a process of fixing the ink by drying through hot air.

A coloring process for the inner bottom face 101 of the three-dimensional shaped object 100 using the coloring unit 113 will now be described.

First, the second data creation unit 25B extracts color data DA2 representing color of the inner bottom face 101 from the 3D data DA in cooperation with the operation processing unit 23 and creates second data D2 for printing an image corresponding to the color data DA2. Note that, when the inner bottom face 101 has a curved profile or the like, the second data creation unit 25B converts the image corresponding to the color data DA2 into a planarly developed image and creates the second data D2 for printing the converted image. Note that the data creation process may be independently performed by the second data creation unit 25B.

Next, the coloring unit 113 prints the image on the transfer surface 67A of the transfer member 67 using the print head 62, based on the second data D2 under control of the operation processing unit 23 and then moves the print head 62 to a standby position distant from the transfer member 67. Then, the operation processing unit 23 moves the three-dimensional shaped object 100 downward to the transfer member 67 using the conveyance unit 14.

In this case, since the transfer member 67 is flexible, the transfer member 67 is deformed to match the recessed shape of the three-dimensional shaped object 100. Even when the inner bottom face 101 of the three-dimensional shaped object 100 is uneven, the transfer member 67 is deformed to match the unevenness. Therefore, it is possible to allow the transfer surface 67A to abut on substantially the entire area of the inner bottom face 101. As a result, it is possible to transfer the transfer image printed on the transfer surface 67A to the inner bottom face 101. Then, the coloring of the inner bottom face 101 is completed by performing the fixation process using the fixation unit 64.

Note that the aforementioned transfer member 67 may be widely applicable to coloring of various recessed areas of the three-dimensional shaped object 100, and the application is not limited to the coloring of the inner bottom face 101 of the three-dimensional shaped object 100. In addition, the three-dimensional shaped object 100 may be colored by moving the transfer member 67.

In this manner, the coloring unit 113 according to the second exemplary embodiment has the transfer member 67 deformable along the surface of the three-dimensional shaped object 100 and capable of printing the transfer image, based on the second data D2. In addition, the coloring unit 113 transfers the transfer image to the three-dimensional shaped object 100 by bringing the transfer member 67 and the three-dimensional shaped object 100 into contact with each other. As a result, it is possible to easily color even an inner surface of the recessed area such as the inner bottom face 101 where printing is difficult through the water pressure transfer.

In addition, the transfer member 67 may be used to color a part other than the recessed area, for example, an uneven surface such as a protuberance, a curved surface, and the like.

Therefore, the shaping apparatus 10 according to the second exemplary embodiment can easily fabricate a color three-dimensional shaped object 100 including a recessed area and the like.

Since the coloring unit 113 prints the transfer image on the transfer member 67 using the print head 62 based on the inkjet technology, it is possible to easily print a high-quality image on the transfer member 67 using the print head known in the art. In addition, the shaping apparatus 10 may further have the configuration of the coloring unit 13 of the first exemplary embodiment. In this case, it is possible to selectively use each of the coloring units 13 and 113 depending on a target coloring portion of the three-dimensional shaped object 100.

### Third Exemplary Embodiment

A third exemplary embodiment of the present invention will now be described.

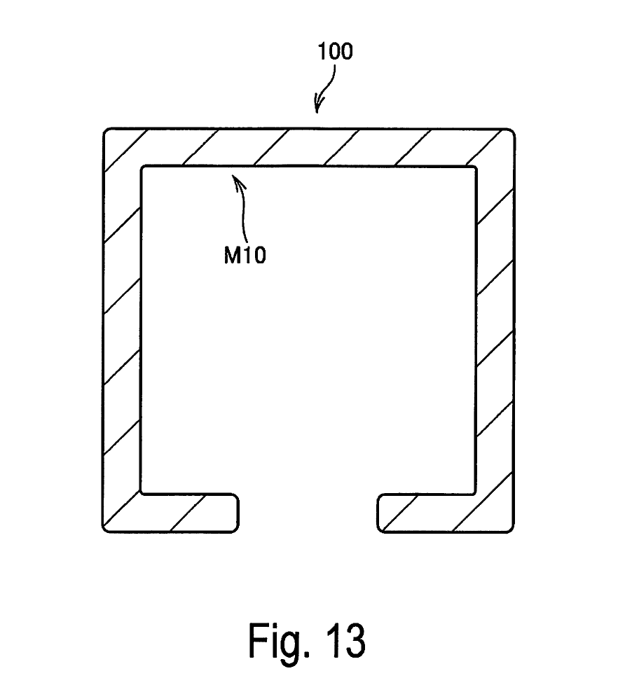

In coloring of a three-dimensional shaped object, there is a face where the coloring is difficult after the three-dimensional shaping depending on a shape of the 3D object. For example, in the case of a 3D object (three-dimensional shaped object 100) internally including a cavity portion as illustrated in FIG. 13, it is difficult to perform coloring after the three-dimensional shaping even when the inner surface M10 has a color. Note that FIG. 13 is a cross-sectional view illustrating a 3D object internally including a cavity portion.

In this regard, the shaping apparatus 10 according to the third exemplary embodiment interrupts the three-dimensional shaping and colors the inner surface M10 using the coloring unit 13 when the inner surface M10 (predetermined face) becomes colorable in the middle of the three-dimensional shaping. Then, a process of resuming the three-dimensional shaping (hereinafter, referred to as an “intermediate coloring process”) is performed. Note that the third exemplary embodiment is similar to the first exemplary embodiment except for the intermediate coloring process. The different parts will now be described in detail.

In order to perform the intermediate coloring process, first, the operation processing unit 23 of the control unit 11 performs search processing for searching a face MM where coloring is difficult (hereinafter, referred to as a “face difficult to color”) before starting the three-dimensional shaping (before starting the aforementioned step S3) and after the three-dimensional shaping.

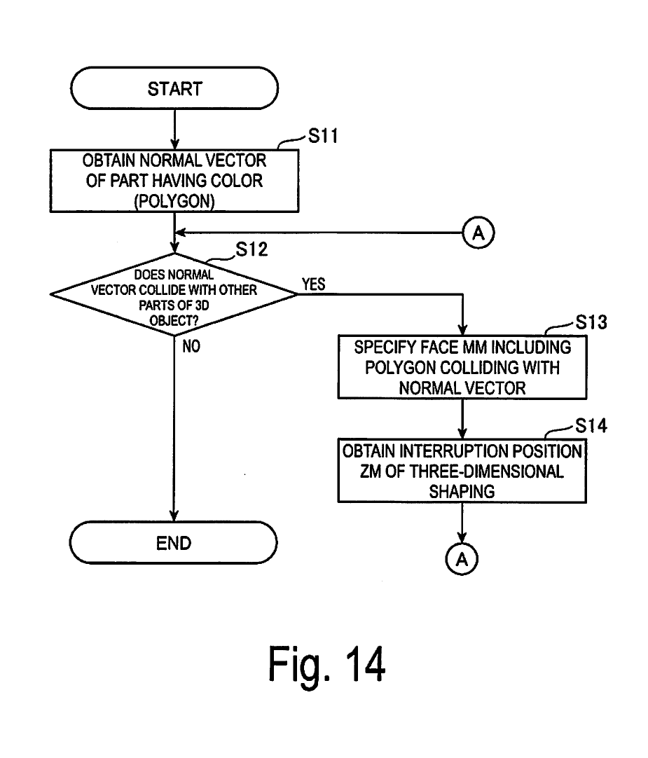

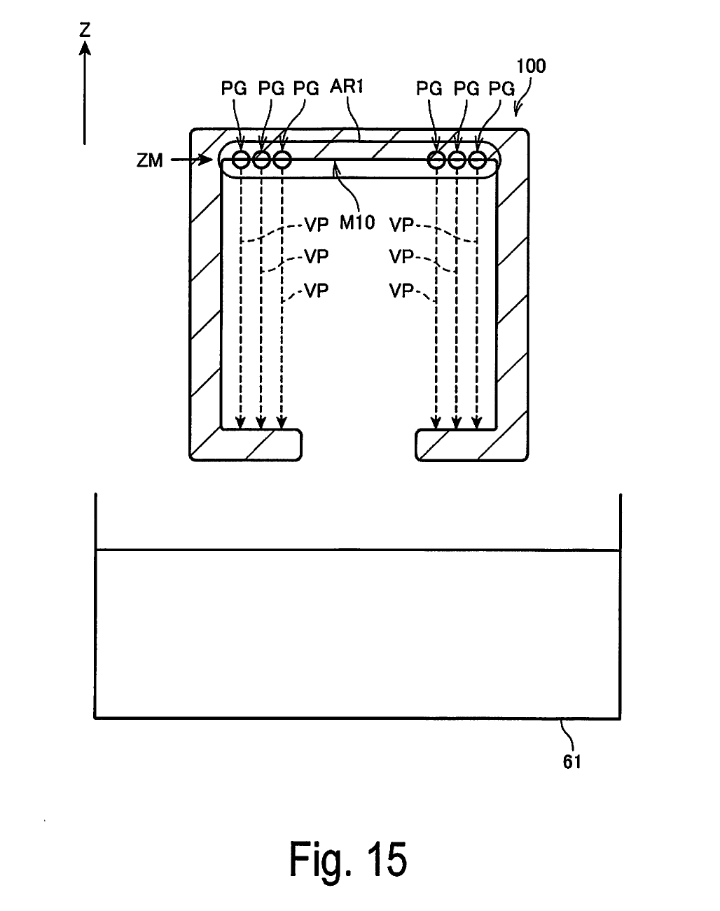

FIG. 14 is a flowchart illustrating the search processing. In addition, FIG. 15 is a diagram for describing the search processing. FIG. 15 illustrates a positional relationship between the 3D object (three-dimensional shaped object 100) of FIG. 13 and the water surface (transfer surface) of the transfer tank 61. In FIG. 15, it is assumed that the water pressure transfer is performed for the 3D object from the negative side of the Z axis. In addition, the 3D object is shaped from the upper end to the lower end of FIG. 15.

First, the operation processing unit 23 obtains normal vectors of each part having a color on the 3D object (corresponding to a polygon), based on the 3D data DA (step S11). The normal vectors may be obtained, based on the coordinate information included in the 3D data DA. Here, in FIG. 15, the element PG is a polygon present on the inner surface M10, and the elements VP are normal vectors of each polygon PG.

Then, the operation processing unit 23 determines whether or not each normal vector VP collides with another part of the 3D object (step S12). In a case where a normal vector VP collides with another part (step S12: YES), it is determined that the normal vector is from a part that forms an inner surface of the 3D object (polygon). For this reason, the operation processing unit 23 specifies the face including the polygon PG having the colliding normal vector VP (inner surface M10) as the face difficult to color MM (step S13).

In this case, the operation processing unit 23 specifies the entire faces continuous in parallel with the transfer surface (water surface) (at least in any one of the X and Y directions) as the face difficult to color MM. As a result, the entire surface M10 having the area indicated by reference numeral AR1 in FIG. 15 is specified as the face difficult to color MM.

Subsequently, the operation processing unit 23 obtains a three-dimensional shaping interruption position ZM (step S14). Specifically, the operation processing unit 23 specifies a coordinate value ZM corresponding to a shaping completion position for the face difficult to color MM in a lamination direction (−Z direction) of the three-dimensional shaping unit 12. Then, the process advances to step S12, and the operation processing unit 23 searches another face difficult to color M. Therefore, in a case where there is another inner surface having a color, this surface is also specified as the face difficult to color 1M.

In a case where the determination of step S12 is negative, that is, in a case where no normal vector VP collides with another part of the 3D object (step S12: NO), the operation processing unit 23 terminates the search processing. Described above is the search processing.

Note that, although the case where the search processing is performed by the operation processing unit 23 alone has been described, the operation processing unit 23 and the second data creation unit 25B may perform the search processing in cooperation, or the second data creation unit 25B may perform the search processing alone.

As the search processing is terminated, the operation processing unit 23 causes the three-dimensional shaping unit 12 to start the three-dimensional shaping. In this case, in a case where there is no face difficult to color 1N in the 3D object, the operation processing unit 23 does not interrupt the three-dimensional shaping.

By contrast, in a case where there is a face difficult to color 16 in the 3D object, the operation processing unit 23 monitors whether or not the three-dimensional shaping is performed up to the coordinate value ZM corresponding to the shaping completion position of the face difficult to color NM. In addition, in a case where the three-dimensional shaping is performed up to the coordinate value ZM, the operation processing unit 23 interrupts the three-dimensional shaping by the three-dimensional shaping unit 12. Then, the operation processing unit 23 causes the conveyance unit 14 to convey the unfinished three-dimensional shaped object 100 to the coloring unit 13 and causes the coloring unit 13 to color the image corresponding to the face difficult to color 1M. That is, since the face difficult to color MM is exposed to outside while the three-dimensional shaped object 100 is under the shaping, it is possible to easily color the three-dimensional shaped object 100 using the coloring unit 13.

Here, as a control of the three-dimensional shaping up to the coordinate value ZM, the operation processing unit 23 may instruct interruption of the three-dimensional shaping at the timing of the coordinate value ZM or may instruct to perform the three-dimensional shaping up to the coordinate value ZM in advance. For example, the first data creation unit 25A may separately create data for performing three-dimensional shaping up to the coordinate value ZM and data as the first data D1 for performing the three-dimensional shaping after the coordinate value ZM, and the three-dimensional shaping may be performed, based on the data for performing the three-dimensional shaping up to the coordinate value ZM.

Note that the operation processing unit 23 causes the second data creation unit 25B to create the print data for printing an image of the face difficult to color MM as the second data D2 after the search processing.

As the printing for the face difficult to color MM is terminated, the operation processing unit 23 causes the conveyance unit 14 to convey the three-dimensional shaped object 100 to the three-dimensional shaping unit 12 and causes the three-dimensional shaping unit 12 to resume the three-dimensional shaping. In addition, as the shaping of the three-dimensional shaped object 100 is completed, the operation processing unit 23 causes the conveyance unit 14 to convey the three-dimensional shaped object 100 to the coloring unit 13 and causes the coloring unit 13 to color the remaining parts. As a result, a three-dimensional shaped object 100 is fabricated by coloring the inner surface M10, an outer surface, and the like where coloring is difficult after the three-dimensional shaping.

As described above, in the shaping apparatus 10 according to the third exemplary embodiment, the operation processing unit 23 interrupts the three-dimensional shaping in the middle of the three-dimensional shaping by the three-dimensional shaping unit 12. In addition, the operation processing unit 23 causes the conveyance unit 14 to convey the three-dimensional shaped object 100 and causes the coloring unit 13 to color the surface of the three-dimensional shaped object 100. Then, the operation processing unit 23 causes the conveyance unit 14 to convey the three-dimensional shaped object 100 and resumes the three-dimensional shaping. Using such a configuration and such a control method, it is possible to easily fabricate the color three-dimensional shaped object 100 by coloring inside.

In this case, as the face difficult to color MM (predetermined face) which is the inner surface M10 of the three-dimensional shaped object 100 becomes colorable, the operation processing unit 23 interrupts the three-dimensional shaping by the three-dimensional shaping unit 12 in the middle, causes the conveyance unit 14 to convey the three-dimensional shaped object 100, and causes the coloring unit 13 to color the face difficult to color MM. As a result, it is possible to color the face difficult to color MM that becomes colorable in the middle of the three-dimensional shaping.

Here, the inner surface M10 becomes easily colorable in the middle of the three-dimensional shaping even when the inner surface M10 is a surface where coloring is difficult after the three-dimensional shaping of the 3D object.

The operation processing unit 23 performs the search processing for searching the face difficult to color MN, based on the input 3D data DA. In a case where face difficult to color MM is not searched, the three-dimensional shaping by the three-dimensional shaping unit 12 is not interrupted. As a result, it is possible to rapidly terminate the three-dimensional shaping.

As the search processing, the operation processing unit 23 obtains normal vectors of each part having color in the 3D object, based on the 3D data DA and determines whether or not each normal vector collides with another part of the 3D object. Based on the determination result, the operation processing unit 23 detects the surface including the part having the colliding normal vector as the face difficult to color MM. As a result, it is possible to search the inner surface M10 where coloring is difficult with high accuracy after the three-dimensional shaping.

The operation processing unit 23 sets a position of the three-dimensional shaping unit 12 in the laminate direction (−Z direction) corresponding to the shaping end position of the face difficult to color MM as the interruption position ZM of the three-dimensional shaping. As a result, it is possible to interrupting the three-dimensional shaping while the face difficult to color MM is exposed to the outside. Therefore, it is possible to facilitate coloring.

### Fourth Exemplary Embodiment

A fourth exemplary embodiment of the present invention will now be described.

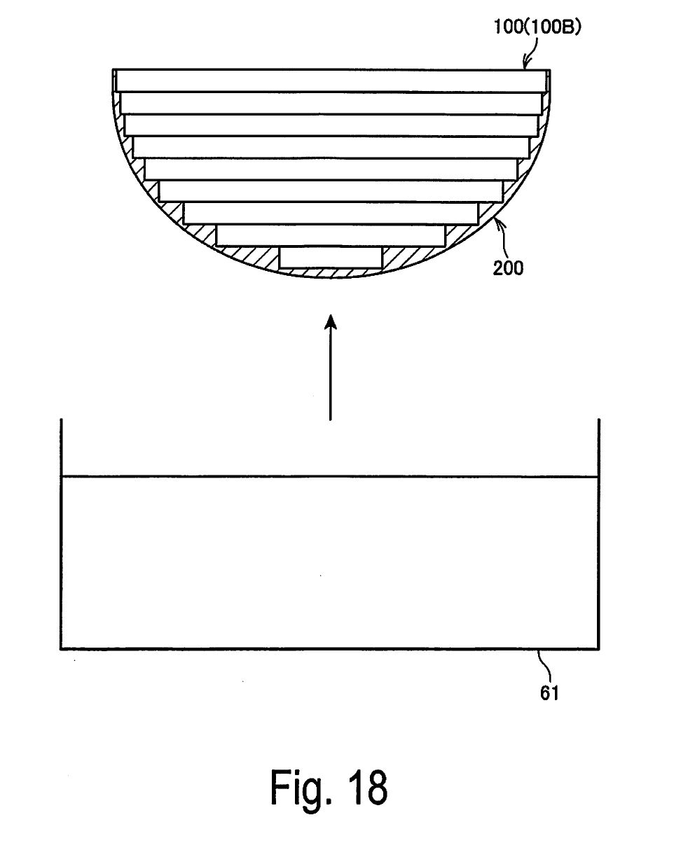

In shaping of a three-dimensional shaped object, an unevenness is formed on the three-dimensional shaped object 100 shaped by the three-dimensional shaping unit 12 depending on a shaping control resolution. For example, a step may be formed between layers of the three-dimensional shaped object 100. In this regard, as a coloring process of the coloring unit 13, the shaping apparatus 10 according to the fourth exemplary embodiment forms a surface layer 200 (FIG. 18) capable of flattening the surface of the three-dimensional shaped object 100 on the three-dimensional shaped object 100. Note that the fourth exemplary embodiment is similar to the first exemplary embodiment except for the surface layer 200. The different parts will now be described in detail.

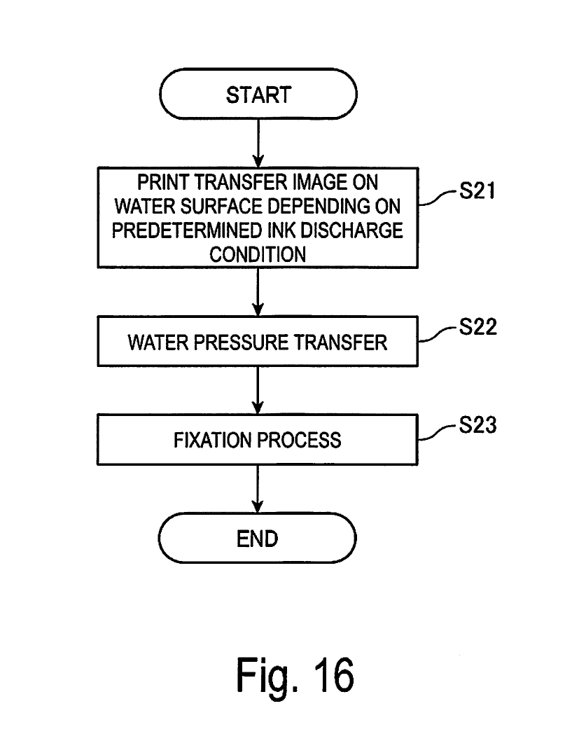

FIG. 16 is a flowchart illustrating a coloring process.

As illustrated in FIG. 16, the coloring unit 13 discharges ink from the print head 62 depending on a predetermined ink discharge condition to print a transfer image corresponding to the second data D2 on the water surface while the control unit 11 controls the operation processing unit 23 (step S21).

The ink discharge condition defines the amount of ink discharged from the print head 62. In this case, the amount of the discharged ink is defined such that an unevenness that may be formed on the surface of the three-dimensional shaped object 100, specifically, a step between layers and the like is filled. For example, the ink amount increases as the size of the step between layers increases. As described above, since the first data D1 regarding the shape of each layer is obtained from the 3D data DA of the three-dimensional shaped object 100 by dividing the 3D object into multiple layers, the size of the step between layers is known in advance. Therefore, it is possible to determine the amount of the discharged ink depending on the size of the step between layers known in advance. Note that a control performed in the inkjet technology of the related art may be widely employed as the control of the amount of the discharged ink.

Then, the coloring unit 13 transfers the transfer image 130 printed on the water surface to the three-dimensional shaped object 100 (step S22).

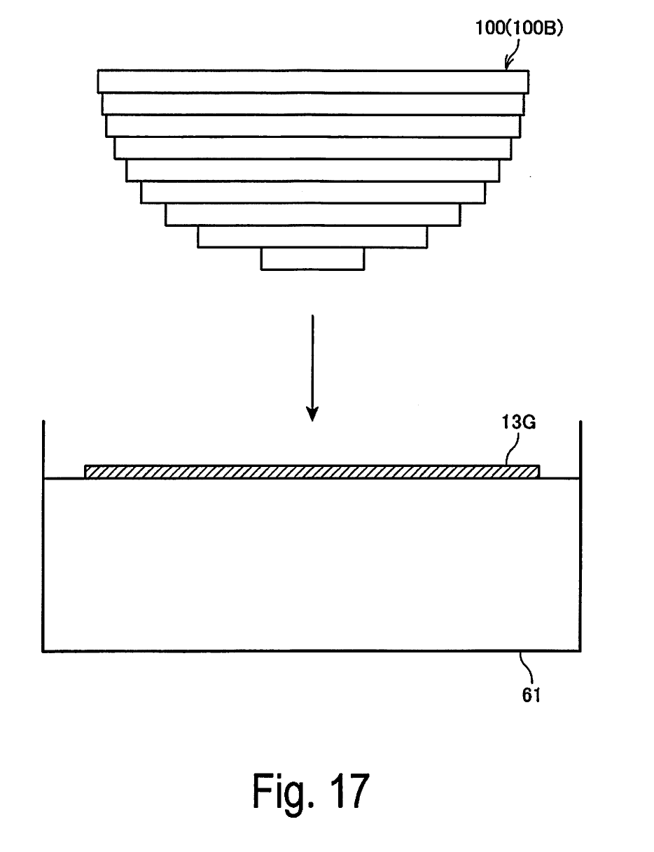

Here, FIG. 17 is a diagram illustrating the three-dimensional shaped object 100 before being transferred and the transfer tank 61. FIG. 18 is a diagram illustrating the three-dimensional shaped object 100 after being transferred and the transfer tank 61. Note that, in FIGS. 17 and 18, the step between layers on the three-dimensional shaped object 100 is illustrated emphatically.

The transfer image 13G of FIG. 17 is an image printed with the amount of ink by which a step between layers of the three-dimensional shaped object 100 is filled. As a result, when the transfer image 13G is transferred to the three-dimensional shaped object 100, the transfer image 13G is transferred such that an unevenness of the three-dimensional shaped object 100, specifically, a step between layers and the like is filled as illustrated in FIG. 18. Therefore, it is possible to obtain the surface layer 200 that flattens the surface of the three-dimensional shaped object 100. In practice, some unevenness may remain on the surface of the surface layer 200 in some cases. However, the surface unevenness of the surface layer 200 is smoother than the original unevenness of the three-dimensional shaped object 100 due to surface tension. That is, the flattening is considered to be sufficient.

Subsequently, as illustrated in FIG. 16, the coloring unit 13 causes the fixation unit 64 to perform a fixation process to fix the surface layer 200 (step S23). As a result, the surface layer 200 is fixed. By setting the ink discharge condition of the coloring unit 13 in this manner, it is possible to form the surface layer 200 that flattens the surface of the three-dimensional shaped object 100 and has color based on the second data D2.

The aforementioned ink discharge condition may be set depending on the unevenness of the three-dimensional shaped object 100, that is, a control resolution of the three-dimensional shaped object 100 (including the slice width of the three-dimensional shaped object 100) or may be changed depending on the control resolution of the three-dimensional shaped object 100. When the ink discharge condition is changed, a table data or a relational expression describing a matching relationship between the control resolution (slice width) of the three-dimensional shaped object 100 and the ink discharge condition may be stored, and the ink discharge condition may be set, based on the stored information. For example, in a case where a difference of the unevenness of the three-dimensional shaped object 100 (for example, the step between layers) is small, the amount of ink for the part corresponding to this position in the transfer image 13G may be reduced.

The ink discharge condition may be suitably changed as long as the surface of the three-dimensional shaped object 100 is flattened. Note that, although photocurable ink may be suitable for forming a thick surface layer 200, any type of ink other than the photocurable ink may be employed. In addition, ink may have viscosity at a certain level for forming a thick surface layer 200.

As described above, in the shaping apparatus 10 according to the fourth exemplary embodiment, the coloring unit 13 forms the surface layer 200 that flattens the surface of the three-dimensional shaped object 100 and has a surface color based on the second data D2 in the three-dimensional shaped object 100. Using such a configuration and such a control method, it is possible to easily fabricate the color three-dimensional shaped object 100 with reduced surface unevenness.

Since this surface layer 200 flattens a step formed between layers of the three-dimensional shaped object 100, it is possible to fabricate the color three-dimensional shaped object 100 with reduced surface unevenness while using a three-dimensional shaping unit 12 of laminate shaping type.

Since the coloring unit 13 forms the surface layer 200 on the three-dimensional shaped object 100, based on the water pressure transfer technology, it is possible to transfer the transfer image 13G to completely fill the unevenness of the three-dimensional shaped object 100. This is advantageous for flattening of the unevenness and the like. Furthermore, according to the fourth exemplary embodiment, the surface layer 200 that flattens the surface of the three-dimensional shaped object 100 is formed by setting the ink discharge condition. Therefore, no special configuration is needed and complication of the configuration can be avoided.

### Fifth Exemplary Embodiment

A fifth exemplary embodiment of the present invention will now be described.

The fifth exemplary embodiment is different from the fourth exemplary embodiment in that the curing process is performed twice in the coloring process.

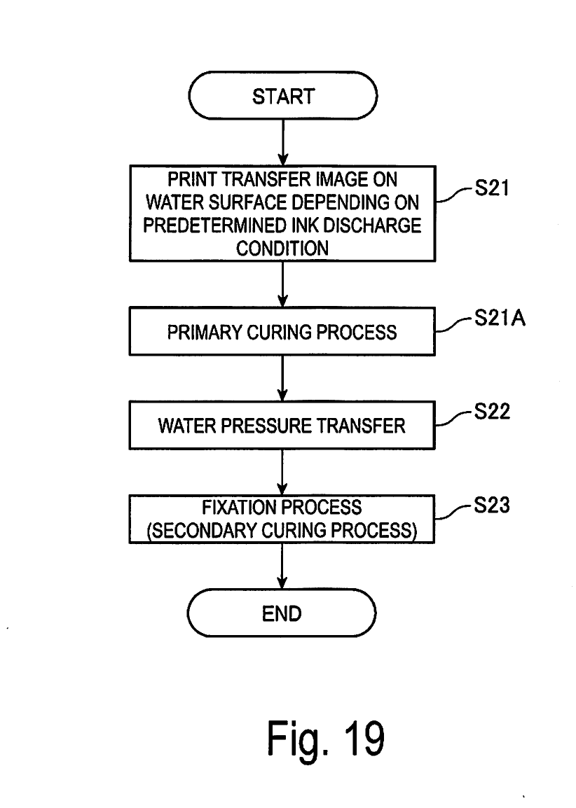

FIG. 19 is a flowchart illustrating the coloring process. Note that, for example, photocurable ink is employed in the fifth exemplary embodiment.

In this coloring process, a primary curing process is performed to the transfer image printed on the water surface of the transfer tank 61 using the fixation unit 64 after the processing of step S21 (step S21A). This primary curing process is not a process for fully curing the ink on the transfer image but a process for curing the transfer image within a range where the water pressure transfer can be performed.

Then, the coloring unit 13 performs the water pressure transfer of the transfer image 13G to the three-dimensional shaped object 100 (step S22). In this case, since the transfer image 13G is not fully cured, ink can flow into a step formed between layers of the three-dimensional shaped object 100 due to a water pressure during the water pressure transfer and cover the surface of the three-dimensional shaped object 100.

Then, the coloring unit 13 performs a fixation process as the secondary curing process for fully curing the ink on the transfer image (corresponding to the surface layer 200) using the fixation unit 64 (step S23). Since the transfer image is transferred to the three-dimensional shaped object 100 after being cured within the transferable range in this manner, it is possible to easily fix the shape of the transfer image (including the thickness). Therefore, it is possible to more easily obtain the surface layer 200 capable of flattening the surface of the three-dimensional shaped object 100.

Compared to the fourth exemplary embodiment, according to the fifth exemplary embodiment, it is possible to easily flatten an unevenness that may be formed on the surface of the three-dimensional shaped object 100, even with moderate ink discharge condition, that is, even with reduced amount of ink. Therefore, depending on the three-dimensional shaped object 100, or when the control resolution of the three-dimensional shaping unit 12 is relatively high, it is possible to form the surface layer 200 that is flattened just by performing the primary curing process without particularly setting the ink discharge condition. In this case, it is possible to perform the ink discharge control, based on a general setting with a focus on image quality.

Note that, when the water pressure transfer is performed using a water pressure transfer film, the primary curing process may be performed for the transfer image printed on the water pressure transfer film.

### Sixth Exemplary Embodiment

A sixth exemplary embodiment of the present invention will now be described.

The sixth exemplary embodiment is different from each of the aforementioned exemplary embodiments in that a surface layer 200A of a multilayered structure is employed as the surface layer.

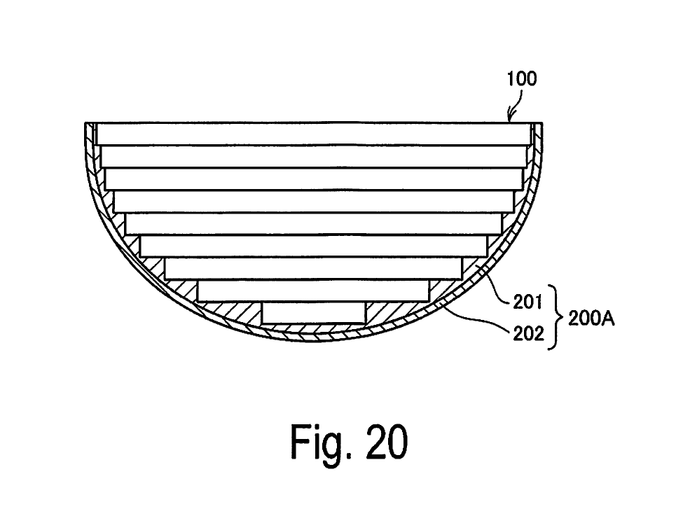

FIG. 20 is a diagram illustrating an exemplary surface layer 200A of the multilayered structure. The surface layer 200A has a two-layered structure including a first layer 201 which forms a layer on the three-dimensional shaped object 100 side and a second layer 202 provided on a side opposite to the three-dimensional shaped object 100 with respect to the first layer 201.

The surface layer 200A of the multilayered structure is formed on a surface layer that flattens the surface of the three-dimensional shaped object 100. That is, the surface layer 200A for flattening the surface of the three-dimensional shaped object 100 is formed by setting the ink discharge condition for any one or both of the first layer 201 and the second layer 202 (each layer 201 and 202). In addition, the surface layer for flattening the surface of the three-dimensional shaped object 100 is formed by applying the primary curing process of the fifth exemplary embodiment to any one or both of the layers 201 and 202.

As a method of forming each layer 201 and 202, a multilayered transfer image may be formed on the water surface or the water pressure transfer film by superposing and printing the first layer 201 on the second layer 202 using the print head 62. In addition, the transfer image may be transferred to the three-dimensional shaped object 100 by performing the water pressure transfer for each layer.

A color layer, colored based on the second data D2, may be formed on at least any one of the layers 201 and 202. In addition, a layer other than the color layer may be formed in the following way.

In a case where the first layer 201 on the three-dimensional shaped object 100 side is a color layer, the second layer 202 may be formed as a transparent clear layer. In this case, it is possible to protect the color layer and easily obtain surface glossiness. Note that the transparent color also includes colored transparency. For example, the second layer 202 may have a transparent pink color.

In a case where the second layer 202 is a color layer, the first layer 201 formed on the three-dimensional shaped object 100 side (as a base layer) may have any one of a white tone, a gray tone, a black tone, a metal tone, and a transparent clear tone. In the case of a white tone, it is possible to improve color development and expand a color reproduction gamut. In addition, in the case of a gray tone or a black tone, it is possible to suppress influence of color of a material of the three-dimensional shaped object 100. In addition, in the case of a metal tone, it is possible to reproduce a metal gloss texture. Furthermore, in the case of a clear tone, it is possible to easily improve fixation of the color layer. Moreover, the surface layer 200A may have three or more layers.

According to the sixth exemplary embodiment, the surface layer 200A capable of flattening the surface of the three-dimensional shaped object 100 has a multilayered structure, and any one of the layers is a color layer, colored based on the second data D2. In this configuration, it is possible to easily obtain an effect of improving color development using a layer other than the color layer, and the like, in addition to the advantages of the aforementioned exemplary embodiments.

In this case, the surface layer 200A has a transparent clear layer provided on a side opposite to the three-dimensional shaped object 100 with respect to the color layer on. Therefore, it is possible to protect the color layer and easily obtain surface glossiness as described above.

The surface layer 200A has a layer having a color contributing to color development of the color layer on the three-dimensional shaped object 100 side with respect to the color layer. As a result, it is possible to easily improve color development, expand a color reproduction gamut, suppress influence of color of a material of the three-dimensional shaped object 100, and reproduce a metal gloss texture and the like as described above.

Note that each of the aforementioned exemplary embodiments exemplifies an aspect of the present invention, and any change or modification may be made within the spirit and scope of the present invention.

For example, in the third exemplary embodiment described above, a case where the inner surface M10 is searched as the face difficult to color MM (predetermined face) has been explained. However, a surface other than the inner surface may be included. For example, a surface where coloring is difficult after the three-dimensional shaping may be included in the face difficult to color MM. As a result, the coloring is performed in a position where the face difficult to color is exposed to outside. Accordingly, it is possible to facilitate coloring.

Further, in the first to third exemplary embodiments described above, the surface layer obtained by causing the coloring unit 13 to color the three-dimensional shaped object 100 may have a multilayered structure.

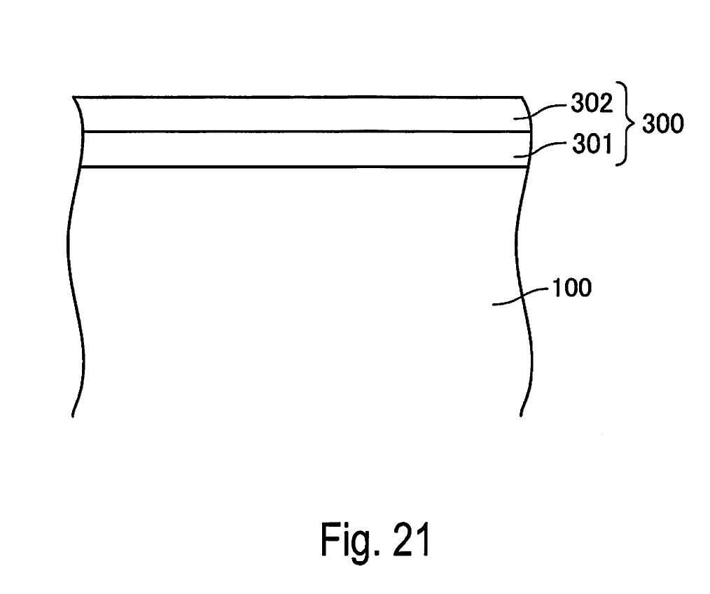

Here, FIG. 21 is a diagram illustrating an exemplary surface layer having a multilayered structure. The surface layer 300 of FIG. 21 includes a first layer 301 serving as a layer on the three-dimensional shaped object 100 side and a second layer 302 provided on a side opposite to the three-dimensional shaped object 100 with respect to the first layer 301. The first and second layers 301 and 302 may be formed through a method of superposing and printing the first layer 301 on the second layer 302 on the water surface or the water pressure transfer film using the print head 62 to form a multilayered transfer image or a method of transferring each layer to the three-dimensional shaped object 100 using the water pressure transfer.

Any one of the first layer 301 and the second layer 302 is formed as a color layer obtained by performing coloring, based on the second data D2. In addition, a layer other than the color layer may be formed in the following way.

In a case where the second layer 302 provided on a side opposite to the three-dimensional shaped object 100 with respect to the first layer 301 is the color layer, the first layer 301 may have any one of a white tone, a gray tone, a black tone, a metal tone, and a transparent clear tone. In the case of a white tone, it is possible to improve color development and expanding a color reproduction gamut. In addition, in the case of a gray tone or a black tone, it is possible to suppress influence of color of a material of the three-dimensional shaped object 100. In addition, in the case of a metal tone, it is possible to reproduce a metal gloss texture. Furthermore, in the case of a clear tone, it is possible to easily improve fixation of the color layer.

In a case where the first layer 301 on the three-dimensional shaped object 100 side is a color layer, the second layer 302 may be formed as a transparent clear layer. In this case, it is possible to protect the color layer and easily obtain surface glossiness. Note that the transparent color also includes colored transparency. For example, the second layer 302 has a transparent pink color. In addition, the surface layer 300 may have three or more layers.

Although a case where the inkjet type print head 62 is employed has been explained in each of the exemplary embodiments described above, any type of the print head known in the art may be employed without a limitation.

When printing is performed on a water pressure transfer film, printing on the film may be performed far from the transfer tank 61, and the water pressure transfer film subjected to the printing may be conveyed by the conveyance unit 14 to a predetermined position or the like on the water surface.

When the transfer member 67 (refer to FIG. 12) is used, the transfer member may be moved to the print position.

Functional blocks of each drawing may be realized in any form by cooperation of hardware and software and are not limited to a specific hardware configuration.

### REFERENCE SIGNS LIST

10 . . . Color three-dimensional shaping apparatus, 11 . . . Control unit, 12 . . . Three-dimensional shaping unit, 13 . . . Coloring unit, 13G . . . Transfer image, 14 . . . Conveyance unit, 21 . . . Data acquisition unit, 22 . . . Storage unit, 23 . . . Operation processing unit, 24 . . . Manipulation input unit, 25 . . . Data creation unit, 25A . . . First data creation unit, 25B . . . Second data creation unit, 26 . . . Notifying unit, 31 . . . Stage, 32 . . . Shape building unit, 33 . . . Shaping driving unit, 41 . . . Conveyance mechanism, 42 . . . Rotation mechanism, 51 . . . Output tray, 61 . . . Transfer tank, 62 . . . Print head, 63 . . . Print driving unit, 64 . . . Fixation unit, 67 . . . Transfer member, 67A . . . Transfer surface, 100, 100A, 100B . . . Three-dimensional shaped object, 101 . . . Inner bottom face, 113 . . . Coloring unit, 200 . . . Surface layer, 201 . . . First layer, 202 . . . Second layer, A, B, C, D . . . Face, AR1 . . . Reference numeral, D1 . . . First data, D2 . . . Second data, DA . . . Three-dimensional data, DA1 . . . Shape data, DA2 . . . Color data, M10 . . . Surface, MM . . . Face difficult to color, MN . . . Number of faces, PG . . . Polygon, P1 . . . Peak, VA, VB, VC, VD . . . Normal vector, Vk . . . Water surface vector, VP . . . Normal vector, ZM . . . Interruption position

1. A color three-dimensional shaping apparatus comprising:
a data acquisition unit configured to acquire data on a 3D object as input data;
a data creation unit configured to create, from the input data, first data regarding shapes of layers obtained by dividing the 3D object into multiple layers and second data regarding a surface color of the 3D object;
a three-dimensional shaping unit configured to three-dimensionally shape the 3D object, based on the first data,
a conveyance unit configured to convey a three-dimensional shaped object three-dimensionally shaped by the three-dimensional shaping unit; and
a coloring unit configured to impart, based on the second data, the surface color to the three-dimensional shaped object conveyed by the conveyance unit.

2. The color three-dimensional shaping apparatus according to claim 1, wherein
the data creation unit is configured to acquire, from the input data, a normal vector of a face having the surface color, specify a colorable plane of the face based on the normal vector, and create the second data representing a transfer image planarly developed on the plane, and
the coloring unit includes a print head for printing the transfer image based on the second data and is configured to transfer the printed transfer image to the three-dimensional shaped object.

3. The color three-dimensional shaping apparatus according to claim 2, wherein
the plane is a plane which enables coloring of a plurality of the faces.

4. The color three-dimensional shaping apparatus according to claim 1, wherein
the coloring unit is configured to color the three-dimensional shaped object by water pressure transfer technology.

5. The color three-dimensional shaping apparatus according to claim 1, wherein
the coloring unit includes a transfer member which is deformable along the surface of the three-dimensional shaped object, and is to be printed with the transfer image based on the second data, and
is configured to bring the transfer member and the three-dimensional shaped object into contact with each other to transfer the transfer image to the three-dimensional shaped object.

6. The color three-dimensional shaping apparatus according to claim 1, wherein
the conveyance unit is configured to rotate the three-dimensional shaped object.

7. The color three-dimensional shaping apparatus according to claim 1, comprising:
a control unit that causes the three-dimensional shaping to be interrupted in a middle of the three-dimensional shaping by the three-dimensional shaping unit, causes the conveyance unit to convey the three-dimensional shaped object, causes the coloring unit to color the three-dimensional shaped object, then causes the conveyance unit to convey the three-dimensional shaped object, and causes the three-dimensional shaping to be resumed.

8. The color three-dimensional shaping apparatus according to claim 7, wherein
the control unit, when a predetermined face of the three-dimensional shaped object becomes colorable, causes the three-dimensional shaping by the three-dimensional shaping unit to be interrupted in the middle, causes the conveyance unit to convey the three-dimensional shaped object, and causes the coloring unit to color the predetermined face.

9. The color three-dimensional shaping apparatus according to claim 8, wherein
the predetermined face is a face where coloring is difficult after the three-dimensional shaping of the 3D object, and the predetermined face includes an inner surface of the 3D object.

10. The color three-dimensional shaping apparatus according to claim 8, wherein
the control unit is configured to perform search processing for searching the predetermined face based on the input data and, when the predetermined face is not searched, does not cause the three-dimensional shaping by the three-dimensional shaping unit to be interrupted.

11. The color three-dimensional shaping apparatus according to claim 10, wherein
in the search processing, the control unit, based on the input data, is configured to obtain respective normal vectors of parts having colors in the 3D object, determine whether or not each of normal vectors collides with another part of the 3D object, and detect a face including a part having a colliding normal vector as the predetermined face.

12. The color three-dimensional shaping apparatus according to claim 1, comprising:
the coloring unit configured to flatten the surface of the three-dimensional shaped object and form a surface layer imparted, based on the second data, with the surface color, for the three-dimensional shaped object conveyed by the conveyance unit.

13. The color three-dimensional shaping apparatus according to claim 12, wherein
the surface layer flattens steps generated between the layers of the three-dimensional shaping unit.

14. The color three-dimensional shaping apparatus according to claim 12, wherein
the coloring unit is configured to impart the surface layer on the three-dimensional shaped object by water pressure transfer technology.

15. The color three-dimensional shaping apparatus according to claim 12, wherein
the surface layer has a multilayered structure, any layer of which is a color layer having been colored based on the second data.

16. The color three-dimensional shaping apparatus according to claim 15, wherein
the surface layer has a transparent clear layer provided on a side opposite to the three-dimensional shaped object with respect to the color layer.

17. The color three-dimensional shaping apparatus according to claim 15, wherein
the surface layer is provided on a side of the three-dimensional shaped object with respect to the color layer and has a layer contributing to color development of the color layer.

18. The color three-dimensional shaping apparatus according to claim 12, wherein
the surface layer is formed of a curable resin, and
the coloring unit is configured to primarily cure a transfer image within a transferable range before transferring to the three-dimensional shaped object and secondarily cure the transfer image transferred to the three-dimensional shaped object.

19. A method for controlling a color three-dimensional shaping apparatus, the method comprising:
acquiring data on a 3D object as input data using a data acquisition unit;
creating, from the input data, first data regarding shapes of layers obtained by dividing the 3D object into multiple layers and second data regarding a surface color of the 3D object using a data creation unit;
three-dimensionally shaping the 3D object based on the first data using a three-dimensional shaping unit;
conveying a three-dimensional shaped object three-dimensionally shaped by the three-dimensional shaping unit using a conveyance unit; and
imparting a surface color to the conveyed three-dimensional shaped object based on the second data using a coloring unit.

20. The method for controlling the color three-dimensional shaping apparatus according to claim 19, wherein
the coloring unit is configured to color the three-dimensional shaped object by water pressure transfer technology.

21-27. (canceled)
